(19) United States
(12) Patent Application Publication
(10) Pub. No.: US 2025/0362244 A1
(43) Pub. Date: Nov. 27, 2025

(54) X-RAY INSPECTION DEVICE AND OPERATING METHOD THEREOF

(71) Applicant: SK On Co., Ltd., Seoul (KR)

(72) Inventors: Sang Ki KIM, Daejeon (KR); Joo Yeong KIM, Daejeon (KR); Jin Ho YU, Daejeon (KR); Min Gyu LEE, Daejeon (KR); Byoung Hak LEE, Daejeon (KR); Eun Jin CHO, Daejeon (KR)

(21) Appl. No.: 19/215,329

(22) Filed: May 22, 2025

(30) Foreign Application Priority Data
May 24, 2024 (KR) 10-2024-0067753

(51) Int. Cl. G01N 23/04

(52) U.S. Cl. CPC G01N 23/04; G01N 2223/1016; G01N 2223/306; G01N 2223/309; G01N 2223/316; G01N 2223/643

(57) ABSTRACT

An X-ray inspection device according the present disclosure includes an X-ray output part irradiating X-rays, a transfer part transferring a battery to a location where X-rays are irradiated, an X-ray detector detecting the X-rays and obtaining a plurality of gray values, a signal processor acquiring an X-ray image including the plurality of gray values, and an inspector determining suitability of inspection settings by analyzing the plurality of gray values of the X-ray image, in which the X-ray output part comprises: an X-ray emitter emitting the X-rays, and a shutter exposing the X-ray emitter to the outside by an opening operation.

### CROSS-REFERENCE TO RELATED PATENT APPLICATION

The present application claims priority under 35 U.S.C. § 119 (a) to Korean patent application number 10-2024-0067753 filed on May 24, 2024 in the Korean Intellectual Property Office, the entire disclosure of which is incorporated by reference herein.

### BACKGROUND OF THE INVENTION

### 1. Field

The present disclosure relates to an X-ray inspection device and an operating method thereof.

### 2. Description of the Related Art

Recently, with the increasing demand for mobile devices such as smartphones, tablet PCs, and wireless earphones, as well as the development of electric vehicles, storage batteries for energy storage, robots, and satellites, research on high-performance batteries that can be repeatedly charged and discharged as an energy source has been actively conducted.

A battery may include a cathode, an anode, and a separator disposed therebetween. The cathode, the separator, and the anode may be stacked sequentially through a stacking process. During the stacking process, electrode misalignment may occur, causing the alignment position of the electrodes to deviate from the specifications. As a result, the cathode and the anode may come into direct contact, causing a short circuit, which may lead to battery failure or damage, or ignition.

In order to ensure the stability and durability of batteries, a technology that can quickly and accurately detect defects in the alignment of electrodes is required. X-ray inspection methods can be used to inspect the exterior and interior without causing damage to items. The X-ray inspection method is a technology that generates a two-dimensional image by detecting X-rays that have penetrated an object, and the X-ray inspection device includes an X-ray output part and an X-ray inspector.

The X-ray inspector is a consumable configuration that requires replacement when exposed to X-rays for a certain period of time, and it is necessary to minimize the time of exposure to X-rays for long-term use of the X-ray detector.

### SUMMARY OF THE INVENTION

An aspect of the present disclosure is to provide an X-ray inspection device capable of extending the lifetime of an X-ray detector by reducing X-ray exposure time.

An X-ray inspection device and an operating method thereof according to the present disclosure may be widely applied in the fields of electric vehicles, battery charging stations, and other green technologies such as photovoltaics and wind power using batteries. In addition, the present disclosure may be used in eco-friendly mobility, including electric vehicles and hybrid vehicles, to prevent climate change by suppressing air pollution and greenhouse fluid emissions.

An X-ray inspection device according to embodiments of the present disclosure may include an X-ray output part irradiating X-rays, a transfer part transferring a battery to a location where X-rays are irradiated, an X-ray detector detecting the X-rays and obtaining a plurality of gray values, a signal processor acquiring an X-ray image including the plurality of gray values, and an inspector determining the suitability of inspection settings by analyzing the plurality of gray values of the X-ray image, wherein the X-ray output part comprises: an X-ray emitter emitting the X-rays, and a shutter exposing the X-ray emitter to the outside by an opening operation.

In an embodiment, the transfer part may include a stage on which the battery is disposed, and a sensor module irradiating laser light onto the stage and generating a battery detection signal by analyzing a light quantity of reflected laser light.

The X-ray inspection device may further include a controller opening the shutter when the battery is disposed on the transfer part based on the battery detection signal.

In an embodiment, the X-ray output part may further include a collimator forming an opening to limit the X-rays emitted to a region outside the region of interest.

In an embodiment, the collimator may include at least two metal members disposed at predetermined locations.

In an embodiment, the metal members may have a same thickness and include a same material.

In an embodiment, the inspector may determine that the inspection settings are suitable when a first gray value of each of the metal areas corresponding to the metal members in the X-ray image is within a reference gray value range.

In an embodiment, the reference gray value range may be set to different values for different locations of the metal areas.

In an embodiment, the inspector may determine an average value of a maximum gray value and a minimum gray value in each of the metal areas as the first gray value.

In an embodiment, the inspector may determine that the inspection settings are suitable when a difference between a first gray value of each of the metal areas corresponding to the metal members in the X-ray image and a second gray value of the region of interest in the X-ray image is within a reference value.

An operating method of an X-ray inspection device according to embodiments of the present disclosure may include acquiring an X-ray image by detecting X-rays irradiated from an X-ray output part, calculating a first gray value of each of metal areas corresponding to metal members in the X-ray image, primarily determining whether a first gray value is within a reference gray value range, determining a second gray value of a region of interest in the X-ray image, secondarily determining whether a difference between the first gray value and the second gray value is within a reference value, and determining the suitability of inspection settings for a battery inspection when primary and secondary determinations satisfy criteria.

In an embodiment, the operating method may further include, before the acquiring of the X-ray image, detecting the battery disposed on the transfer part and opening a shutter.

### BRIEF DESCRIPTION OF THE DRAWINGS

FIG. 1 is a diagram illustrating an X-ray inspection device according to an embodiment of the present disclosure.

FIG. 2 is a block diagram illustrating an X-ray output part according to an embodiment of the present disclosure.

FIG. 3 is a block diagram illustrating a transfer part according to an embodiment of the present disclosure.

FIG. 4 is a diagram illustrating an X-ray output part according to an embodiment of the present disclosure.

FIGS. 5A and 5B are diagrams illustrating a method of operating a shutter according to an embodiment of the present disclosure.

FIG. 6 is a diagram illustrating a region of interest according to an embodiment of the present disclosure.

FIG. 7 is a diagram illustrating a method of determining the suitability of inspection settings according to an embodiment of the present disclosure.

FIG. 8 is a diagram illustrating a method of operating an X-ray inspection device according to an embodiment of the present disclosure.

### DETAILED DESCRIPTION

Advantages and features of the present invention and methods for achieving them will be made clear from embodiments described below in detail with reference to the accompanying drawings. However, they may be embodied in different forms and should not be construed as limited to the embodiments set forth herein. Rather, these embodiments are provided so that this disclosure will be thorough and complete, and will fully convey the scope of the invention to those skilled in the art. The scope of the present invention is defined solely by the claims.

The terminology used herein is for describing particular embodiments only and is not intended to be limiting. It will be further understood that the terms “comprises” and/or “comprising” when used in this specification specify the presence of stated components, but do not preclude the presence or addition of one or more other components. As used herein, the term “and/or” includes any and all combinations of one or more of the associated listed items. In this specification, like reference numerals have been used for like elements. It will be understood that, although the terms “first”, “second”, etc. may be used herein to describe various elements, these elements should not be limited by these terms. These terms are only used to distinguish one element from another element. Therefore, a first element discussed below could be termed a second element without departing from the scope of the invention.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

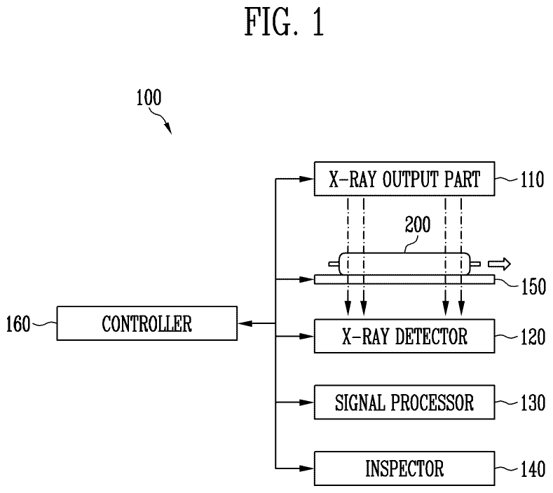

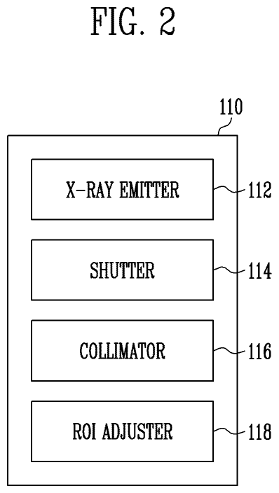

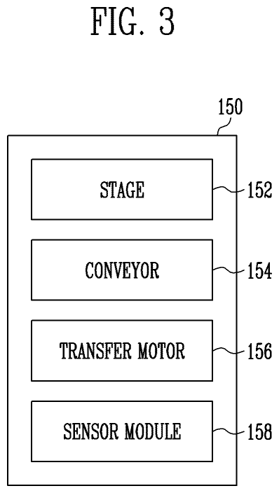

FIG. 1 is a diagram illustrating an X-ray inspection device 100 according to an embodiment of the present disclosure, FIG. 2 is a block diagram illustrating an X-ray output part 110 according to an embodiment of the present disclosure, and FIG. 3 is a block diagram illustrating a transfer part 150 according to an embodiment of the present disclosure.

In an embodiment, An X-ray inspection device may comprise an X-ray output part irradiating X-rays, a transfer part transferring a battery to a location where X-rays are irradiated, an X-ray detector detecting the X-rays and obtaining a plurality of gray values, a signal processor acquiring an X-ray image including the plurality of gray values, and an inspector determining the suitability of inspection settings by analyzing the plurality of gray values of the X-ray image. Further, the X-ray output part may comprise an X-ray emitter emitting the X-rays, and a shutter exposing the X-ray emitter to the outside by an opening operation.

For example, referring to FIGS. 1 to 3, the X-ray inspection device 100 according to an embodiment may include the X-ray output part 110, an X-ray detector 120, a signal processor 130, an inspector 140, the transfer part 150, and a controller 160.

The X-ray output part 110 may generate X-rays. The X-rays may be electromagnetic waves having the property of penetrating an object. For example, the X-ray may be an electromagnetic wave having a wavelength of 0.01 nm to 10 nm.

In an embodiment, the X-ray output part may further comprise a collimator forming an opening to limit the X-rays emitted to a region outside the region of interest.

For example, the X-ray output part 110 may include an X-ray emitter 112 which includes an X-ray tube, a voltage generator, and a current source, a shutter 114 which is operated to open or close by the controller 160, a collimator 116 which limits an area to be irradiated with X-rays, and an ROI adjuster 118 which adjusts a region of interest by controlling the position of the collimator 116. The region of interest is the area where an anode cell and a cathode cell of a battery 200 are imaged.

The X-ray tube of the X-ray emitter 112 may include an anode, a cathode, and a vacuum tube. The anode and the cathode may be disposed within the vacuum tube. For example, each of the anode and the cathode may include a metal, such as tungsten (W), molybdenum (Mo), chromium (Cr), rhenium (Re), copper (Cu), cobalt (Co), iron (Fe), tantalum (Ta), zirconium (Zr), nickel (Ni), or an alloy thereof. The X-ray tube may be of one of two types: a closed type having a structure in which the inside of the vacuum tube is sealed under vacuum and an open type having a structure in which the inside of the vacuum tube is kept under vacuum when a separate vacuum pump is operated. When the X-ray emitter 112 has an open type structure, the X-ray emitter 112 may further include a vacuum pump. The vacuum pump may create a vacuum inside the vacuum tube.

The current source in the X-ray emitter 112 may apply a current to heat a filament of the anode, which may generate heat electrons in the anode. The voltage generator may accelerate the thermal electrons by applying a high voltage between the anode and the cathode. For example, the high voltage may be in kV. The accelerated thermal electrons may strike the cathode and generate X-rays. A test object may be irradiated with the generated X-rays.

The X-ray emitter 112 may irradiate the battery 200 with X-rays. The battery 200 may be a secondary battery which is reusable by charging even after being discharged. For example, the battery 200 may be a lithium-ion battery. The battery 200 may include a plurality of electrode layers and a separator disposed between the plurality of electrode layers. The plurality of electrode layers may include at least one anode layer and at least one cathode layer.

The shutter 114 may perform an opening operation or a closing operation under the control of the controller 160. Through an opening operation, the shutter 114 may expose the X-ray emitter 112 to the outside. The X-ray emitter 112 may irradiate the battery 200 with X-rays in the opening operation of the shutter 114. The shutter 114 may block the X-ray emitter 112 from the outside by the closing operation. X-rays emitted from the X-ray emitter 112 may be blocked by the closing operation of the shutter 114 and may not be exposed to the outside.

The collimator 116 may be used to attenuate the amount of X-rays irradiated to the X-ray detector 120 such that only the region of interest within the maximum FOV may be imaged. In addition, the collimator 116 may form an opening to focus X-rays into the region of interest and limit X-rays emitted to regions outside the region of interest. The position of the opening of the collimator 116 may be adjusted so as to focus X-rays into the region of interest.

In an embodiment, the collimator 116 may be formed by four square-shaped plates positioned at the top, bottom, left, and right, respectively, on the basis of a direction in which the X-rays emitted from the X-ray emitter 112 travel. By the arrangement of the four square-shaped plates, the opening through which the X-rays are output may be formed in the center. The opening of the collimator 116 may have various shapes depending on the configuration of the collimator 116.

The collimator 116 may include at least two metal members disposed at predetermined locations. Each of the metal members may be disposed in a through-hole formed in the collimator 116.

In an embodiment, the metal members may have the same thickness and include the same material. For example, the metal members may include a metal such as tungsten (W), molybdenum (Mo), chromium (Cr), rhenium (Re), copper (Cu), cobalt (Co), iron (Fe), tantalum (Ta), zirconium (Zr), nickel (Ni), or an alloy thereof. For example, each of the metal members may have a thickness of 1 mm.

The ROI adjuster 118 may adjust the area and position of the opening by controlling the position of the collimator 116. In an embodiment, the ROI adjuster 118 may be an adjustment pin which moves the collimator 116 in a horizontal direction upon rotation. For example, the ROI adjuster 118 may be an adjustment pin which controls the position of each of the four collimators 116 positioned at the top, bottom, left, and right. Each of the four collimators 116 may be moved in a horizontal direction upon control of each adjustment pin.

The X-ray detector 120 may be disposed at an opposing position of the X-ray output part 110. The X-ray detector 120 may acquire a plurality of gray values based on the X-rays which have penetrated the battery 200. The gray values may be inversely proportional to the intensity of the X-rays. For example, a lower intensity of the X-ray may result in a higher gray value.

The X-ray detector 120 may include a plurality of pixels. The plurality of pixels may be arranged in row and column directions. The pixels may detect X-rays which have penetrated a unit area of the battery 200 to obtain a sensing signal.

In an embodiment, a pixel may include a photo-conductor which directly converts X-rays into an electrical signal. In another embodiment, a pixel may include a scintillator which converts X-rays to visible light and a photo-diode which converts the visible light to an electrical signal.

The X-ray detector 120 may include a pixel operation section. The pixel operation section may convert a sensing signal to a digital value to obtain a gray value. The number of gray values may be equal to or proportional to the number of pixels.

In an embodiment, the X-ray detector 120 may acquire a gray value using a time delay integration (TDI) method or a flat panel detection (FPD) method.

The signal processor 130 may acquire an X-ray image. The X-ray image may include a plurality of gray values. The plurality of gray values may be arranged in row and column directions in the X-ray image. Each of the gray values may represent a unit area of the battery 200.

The signal processor 130 may receive gray values from the X-ray detector 120 and acquire an X-ray image including the received gray values. For example, when the signal processor 130 receives gray values per line (or region) from the X-ray detector 120, the signal processor 130 may arrange the currently received gray values on different lines (or regions) such that the current gray values may not overlap on the lines (or regions) on which the previously received gray values are arranged. The signal processor 130 may generate an X-ray image including the gray values arranged in each line (or region). A line may represent a single row or a single column. A region may include a plurality of lines.

The inspector 140 may determine a region corresponding to the battery 200 within the X-ray image.

In an embodiment, the inspector 140 may determine a region corresponding to the battery 200 based on a predetermined pattern included in the X-ray image. For example, a region corresponding to the battery 200 may be set based on a pattern corresponding to the outer contour of the battery 200.

In another embodiment, the inspector 140 may determine a region corresponding to the battery 200 based on a change in gray value in a predetermined direction within the X-ray image. For example, straight lines may be drawn in the top-to-bottom, bottom-to-top, left-to-right, and right-to-left directions on a two-dimensional X-ray image, and a region corresponding to the battery 200 may be set by finding points where the gray value changes rapidly in each direction.

The inspector 140 may analyze the gray value of the X-ray image to determine the suitability of inspection settings. The inspector 140 may analyze the gray value of the X-ray image to determine the suitability of inspection settings for performing a battery inspection when the inspection result conforms to a reference value. On the other hand, the inspector 140 may analyze the gray value of the X-ray image to determine the current status of the X-ray inspection device 100 as an unsuitable status of an inspection setting when the inspection result does not conform to the reference value. For example, when the rated power is not provided from the current source or the voltage generator of the X-ray emitter 112, X-rays of the rated intensity may not be irradiated. As a result, the gray value of the X-ray image may not conform to the reference value, and the inspector 140 may determine the current status of the X-ray inspection device 100 as an unsuitable status of an inspection setting.

In an embodiment, the inspector may determine that inspection settings are suitable when a first gray value of each of the metal areas corresponding to the metal members in the X-ray image is within a reference gray value range.

For example, the inspector 140 may determine a first gray value of each of the metal areas corresponding to the metal members in the X-ray image. The first gray value is a gray value of a pixel corresponding to a metal area in the X-ray image. The inspector 140 may determine whether the first gray value is within a reference gray value range. When the first gray value is within the range of the reference gray value, the inspector 140 may determine the current status as inspection settings to be suitable.

X-rays are irradiated radially. Thus, different amounts of X-rays may be irradiated onto the metal members. Even when the metal members include the same material and have the same thickness, the metal members may appear as different gray values in the X-ray image. Therefore, the reference gray value range may be set to different values at different locations of the metal areas.

In an embodiment, the inspector may determine an average value of a maximum gray value and a minimum gray value in each of the metal areas as the first gray value.

For example, the inspector 140 may determine an average value of the maximum gray value and the minimum gray value of each of the metal areas as the first gray value. In the X-ray image, the region corresponding to the metal area may include a plurality of pixels, and the gray value of each pixel may have a different value. Accordingly, the inspector 140 may calculate a maximum gray value and a minimum gray value for each of the metal areas, and may determine an average of the two values as the first gray value.

In another embodiment, the inspector determines that inspection settings are suitable when a difference between a first gray value of each of the metal areas corresponding to the metal members in the X-ray image and a second gray value of the region of interest in the X-ray image is within a reference value.

For example, the inspector 140 may analyze a difference between a first gray value and a second gray value in the X-ray image to determine the suitability of inspection settings. The second gray value is a gray value of a pixel corresponding to a region of interest in the X-ray image. The second gray value may be an average value of pixels placed at predetermined locations in the region of interest. For example, the second gray value may be the average of the gray values of pixels corresponding to n-th to m-th rows and p-th to q-th columns, where n and p are natural numbers greater than or equal to 1, m is a natural number greater than n, and p is a natural number greater than q. The inspector 140 may determine inspection settings to be suitable when the difference between the first gray value and the second gray value is within a reference value.

The transfer part 150 may move the battery 200 disposed on a stage 152 in a predetermined direction. For example, the predetermined direction may be a horizontal direction. For example, the predetermined direction may be in the X-axis direction.

In an embodiment, the transfer part may comprise a stage on which the battery is disposed, and a sensor module irradiating laser light onto the stage and generating a battery detection signal by analyzing a light quantity of reflected laser light.

For example, the transfer part 150 may include the stage 152, a conveyor 154, a transfer motor 156, and a sensor module 158. The stage 152 may provide a space for the battery 200 to be placed, and may be moved horizontally by the conveyor 154. The transfer motor 156 may transmit a rotational force to the conveyor 154. The conveyor 154 may move the stage 152 from one point to another when the rotational force is transmitted.

The sensor module 158 may detect the presence of the battery 200 on the stage 152. The sensor module 158 may include a light irradiation module and a light receiving module. The light irradiation module may irradiate laser light onto the stage 152. An angle of the laser light irradiated by the light irradiation module may be set to a range such that the reflected laser light may reach the light receiving module.

In an embodiment, the light irradiation module may change an irradiation angle every predetermined period of time so as to determine whether the battery 200 is disposed.

The light receiving module may be spaced apart from the light irradiation module to detect the reflected laser light on the stage 152. The light receiving module may measure a light quantity of the reflected laser light to generate light quantity information. The light receiving module may determine that the battery 200 is disposed on the stage 152 when the generated light quantity information has a value greater than or equal to a reference light quantity. The sensor module 158 may determine whether the battery 200 is disposed on the transfer part 150 and may provide a battery detection signal to the controller 160.

The controller 160 may control the overall operation of the X-ray inspection device 100. In an embodiment, the controller 160 may control the operation of at least one of the X-ray output part 110, the X-ray detector 120, the signal processor 130, the inspector 140, and the transfer part 150. In an embodiment, the controller 160 may perform data communication operations or data processing operations. For example, the controller 160 may include a single processor or a plurality of processors.

In an embodiment, the X-ray inspection device may further comprise a controller opening the shutter when the battery is disposed on the transfer part based on the battery detection signal.

For example, the controller 160 may control the shutter 114 based on a battery detection signal provided from the sensor module 158. The controller 160 may open the shutter 114 to allow X-rays to be irradiated to the outside when the battery 200 is disposed on the stage 152. The controller 160 may close the shutter 114 so that X-rays may not be irradiated to the outside when the battery 200 is not disposed on the stage 152.

In an embodiment, the X-ray inspection device 100 may include the X-ray output part 110, the X-ray detector 120, the signal processor 130, the inspector 140, and the controller 160. The X-ray inspection device 100 may be a single inspection device, but this is only an embodiment. The X-ray inspection device 100 may be a combination of a plurality of electronic devices. For example, a first electronic device may include the X-ray output part 110, the X-ray detector 120, and the controller 160, and a second electronic device may include the signal processor 130 and the inspector 140.

The first electronic device and the second electronic device may transmit and receive data according to various communication specifications. The first electronic device may be in the form of an X-ray inspection facility, and the second electronic device may be implemented in various forms, such as a computer, a laptop computer, a tablet computer, a smartphone, a mobile device, and the like. The X-ray inspection device 100 may be realized as a combination of various electronic devices.

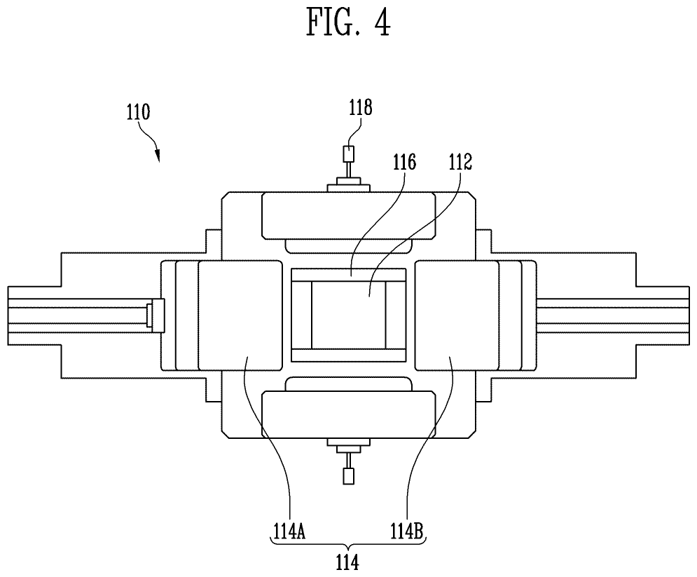

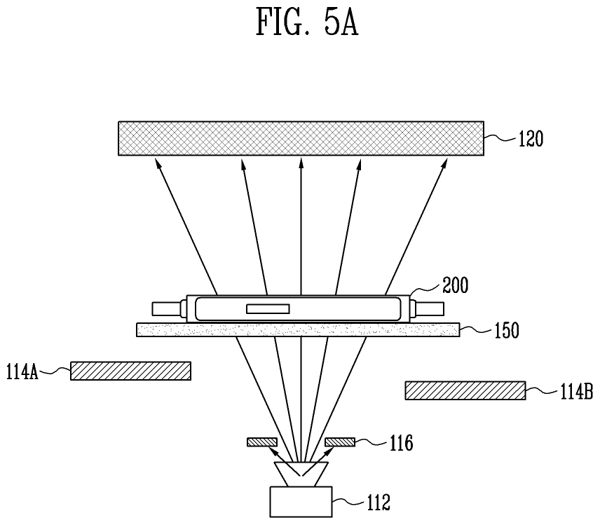

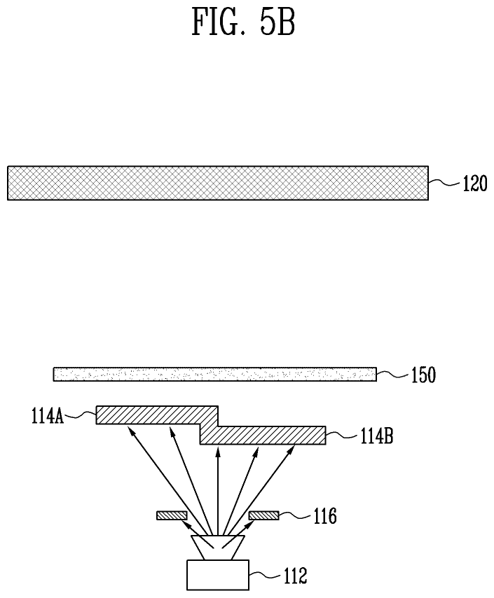

FIG. 4 is a diagram illustrating the X-ray output part 110 according to an embodiment of the present disclosure, and FIGS. 5A and 5B are diagrams illustrating a method of operating the shutter 114 according to an embodiment of the present disclosure.

Referring to FIG. 4, the X-ray output part 110 may include the X-ray emitter 112 which includes an X-ray tube, a voltage generator, and a current source, the shutter 114 which is operated to open or close by the controller 160, the collimator 116 which limits an area to be irradiated with X-rays, and the ROI adjuster 118 which controls the position of the collimator 116 to adjust the region of interest.

The X-ray emitter 112 may include an X-ray tube, a voltage generator, and a current source and irradiate the battery 200 with X-rays.

The shutter 114 may include a first shutter member 114A and a second shutter member 114B. Each of the first shutter member 114A and the second shutter member 114B may be disposed in such a manner that, during a closing operation, each of the first and second shutter members 114A and 114B may move in a horizontal direction to cover a front surface of the X-ray emitter 112. Each of the first shutter member 114A and the second shutter member 114B may move in the horizontal direction during an opening operation to expose the front surface of the X-ray emitter 112 to the outside. However, the present invention is not limited to this, and various other methods known in the art may be provided in addition to the above-described method by horizontal movement of the shutter 114.

The collimator 116 may be formed by four square-shaped plates positioned up, down, left, and right, respectively, based on the direction in which the X-ray radiated from the X-ray emitter 112 proceeds. By the arrangement of the four square-shaped plates, an opening through which the X-rays are output may be formed in the center. The opening of the collimator 116 may have various shapes depending on the configuration of the collimator 116.

The ROI adjuster 118 may control the position of the collimator 116 to adjust the area and position of the opening. The ROI adjuster 118 may be an adjustment pin which moves the collimator 116 in the horizontal direction upon rotation. For example, the ROI adjuster 118 may be an adjustment pin which controls the position of each of the four collimators 116 at the top, bottom, left, and right. Each of the four collimators 116 may be moved in the horizontal direction under the control of each adjustment pin.

Referring to FIGS. 5A and 5B, the X-ray emitter 112 may output X-rays. The collimator 116 may form an opening to focus X-rays to a region of interest, and may limit X-rays emitted to regions other than the region of interest. The position of the opening of the collimator 116 may be adjusted to focus X-rays to the region of interest.

The transfer part 150 may sense the presence of the battery 200 on the stage 152 via the sensor module 158. The sensor module 158 may sense the presence of the battery 200 on the stage 152. The sensor module 158 may determine whether the battery 200 is disposed on the transfer part 150 and may provide a battery detection signal to the controller 160.

The shutter 114 may perform an opening operation or a closing operation under the control of the controller 160. The controller 160 may open the shutter 114 to expose a front surface of the X-ray emitter 112 to the outside when it is determined that the battery 200 is disposed in the transfer part 150 based on the battery detection signal. When the controller 160 determines that the battery 200 is not disposed in the transfer part 150, the controller 160 may close the shutter 114 so that the front surface of the X-ray emitter 112 may be blocked from the outside.

The X-ray detector 120 may include a flat panel detector. The flat panel detector may include a pixel array including a plurality of pixels. For example, the pixel array may include pixels arranged in an a×b configuration.

Each of the pixels may detect transmitted X-rays which have penetrated a unit area of the battery 200, and may obtain a sensing signal for the transmitted X-rays. For example, the sensing signal may be a charge, current, or voltage. A level of the sensing signal may indicate an intensity of the transmitted X-rays. The pixels may correspond to a unit area of the battery 200.

In an embodiment, the level of the detection signal may be inversely proportional to the intensity of the X-rays. For example, a lower intensity of the X-rays may result in a greater level of a sensing signal. In another embodiment, the level of the sensing signal may be proportional to the intensity of the X-rays.

In an embodiment, pixels may include a photo-conductor which directly converts X-rays into an electrical signal. In another embodiment, pixels may include a scintillator which converts X-rays to visible light and a photo-diode which converts visible light to an electrical signal.

In an embodiment, the X-ray detector 120 may include a pixel operation section. The pixel operation section may receive a detection signal and obtain a gray value corresponding to a level of the sensing signal. For example, the pixel operation section may include an analog-to-digital converter which converts an analog signal to a digital signal.

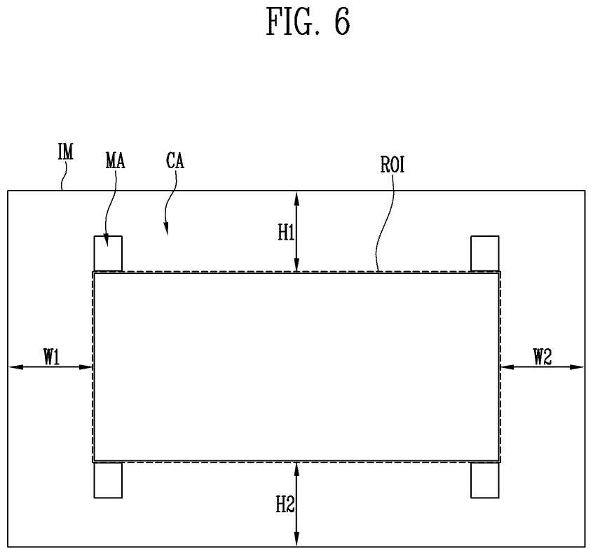

FIG. 6 is a diagram illustrating a region of interest according to an embodiment of the present disclosure.

Referring to FIG. 6, an X-ray image IM captured while the battery 200 is not disposed in the transfer part 150 is shown. The X-ray image IM may include a region of interest ROI, a shielding area CA, and a metal area MA.

The region of interest ROI may be an area where an anode cell and a cathode cell of the battery 200 are imaged, and may be an area where X-rays are not restricted by the collimator 116. The shielding area CA may be an area where X-rays are restricted by the collimator 116. The metal area MA may be an area corresponding to a metal member disposed on the collimator 116. The metal member may be disposed in a through-hole formed in the collimator 116, and X-rays may penetrate the metal member to reach the X-ray detector 120.

The ROI adjuster 118 may control the position of the collimator 116 to adjust heights H1 and H2 and widths W1 and W2 of the shielding area CA. For example, the ROI adjuster 118 may control the position of each of the four collimators 116 positioned at the top, bottom, left, and right to individually adjust each of the heights H1 and H2 and the widths W1 and W2 of the shielding area CA.

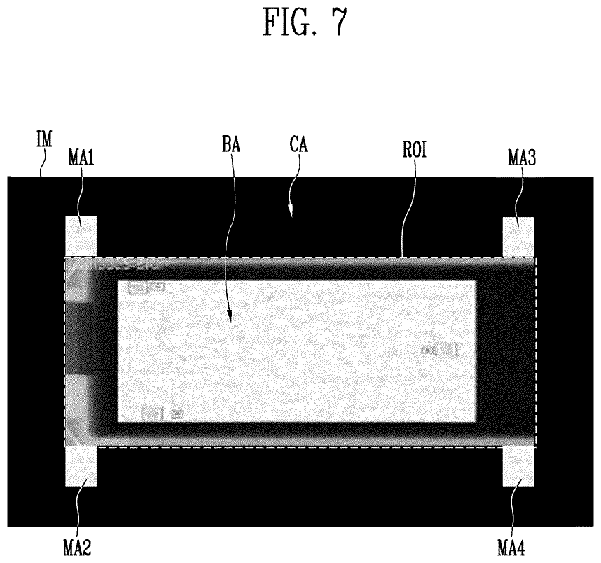

FIG. 7 is a diagram illustrating a method of determining the suitability of inspection settings according to an embodiment of the present disclosure.

Referring to FIG. 7, the X-ray image IM of the cathode cell of the battery 200 is shown. The X-ray image IM may include the region of interest ROI, the shielding area CA, and metal areas MA1, MA2, MA3, and MA4. A battery area BA may correspond to the cathode cell or the anode cell of a battery, and may be included within the region of interest ROI.

The inspector 140 may analyze the gray value of the X-ray image IM to determine the suitability of inspection settings. The inspector 140 may analyze the gray value of the X-ray image IM to determine the suitability of inspection settings for performing the battery inspection when the inspection result meets a reference value.

The inspector 140 may determine a first gray value of each of the metal areas MA1, MA2, MA3, and MA4 corresponding to metal members in the X-ray image IM. The inspector 140 may determine whether the first gray value is within a reference gray value range. When the first gray value is within the reference gray value range, the inspector 140 may determine the current status as inspection settings to be suitable. The reference gray value range may have a different value for each of the metal areas MA1, MA2, MA3, and MA4. For example, the reference gray value range for the first metal area MA1 and the reference gray value range for the second metal area MA2 may have different values.

In an embodiment, the inspector 140 may calculate a maximum gray value and a minimum gray value for each of the metal areas MA1, MA2, MA3, and MA4, and may determine an average of the two values as the first gray value. For example, the inspector 140 may calculate a maximum gray value and a minimum gray value among the gray values of the pixels in the first metal area MA1, and may determine the average of the two values as the first gray value of the first metal area MA1.

In another embodiment, the inspector 140 may analyze a difference between the first gray value and the second gray value in the battery area BA in the X-ray image IM to determine suitability of inspection settings. The inspector 140 may set a gray value at a predetermined location within the battery area BA as the second gray value. The inspector 140 may determine that inspection settings are suitable when the difference between the first gray value and the second gray value is within a reference value.

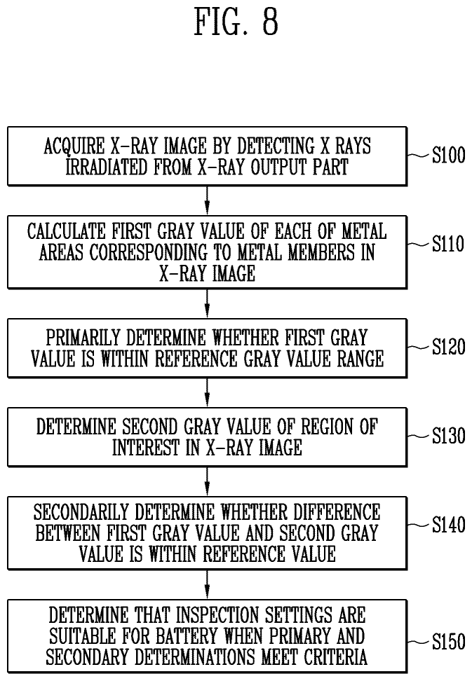

FIG. 8 is a diagram illustrating a method of operating the X-ray inspection device 100 according to an embodiment of the present disclosure.

In another embodiment, an operating method of an X-ray inspection device, the operating method may comprise acquiring an X-ray image by detecting X-rays irradiated from an X-ray output part, calculating a first gray value of each of metal areas corresponding to metal members in the X-ray image, primarily determining whether a first gray value is within a reference gray value range, determining a second gray value of a region of interest in the X-ray image, secondarily determining whether a difference between the first gray value and the second gray value is within a reference value, and determining the suitability of the inspection setting for a battery inspection when primary and secondary determinations satisfy criteria.

For example, referring to FIG. 8, the X-ray inspection device 100 may detect the battery 200 disposed on the transfer part 150 and open the shutter 114. The X-ray inspection device 100 may sense X-rays irradiated from the X-ray output part 110 and acquire an X-ray image at step S100.

For example, the operating method may further comprise, before the acquiring of the X-ray image, detecting the battery disposed on the transfer part and opening a shutter.

The X-ray inspection device 100 may calculate a first gray value for each of the metal areas corresponding to metal members in the X-ray image at step S110.

The X-ray inspection device 100 may primarily determine whether the first gray value is within a range of a reference gray value at step S120.

The X-ray inspection device 100 may determine a second gray value of the region of interest ROI in the X-ray image at step S130.

The X-ray inspection device 100 may secondarily determine whether the difference between the first gray value and the second gray value is within a reference value at step S140.

The X-ray inspection device 100 may determine that the inspection settings of the X-ray inspection device 100 are suitable when the primary and secondary determinations meet the criteria at step S150.

According to an aspect of the present disclosure, X-ray exposure time of an X-ray detector may be reduced by exposing X-rays to the outside only when a position of the battery is detected.

The present disclosure may be modified and implemented in various forms, and its scope is not limited to the above-described embodiments. The content described above is merely an example of applying the principles of the present disclosure, and other features may be further included without departing from the scope of embodiments according to the present disclosure.

What is claimed is:

1. An X-ray inspection device, comprising:
an X-ray output part irradiating X-rays;
a transfer part transferring a battery to a location where X-rays are irradiated;
an X-ray detector detecting the X-rays and obtaining a plurality of gray values;
a signal processor acquiring an X-ray image including the plurality of gray values; and
an inspector determining the suitability of inspection settings by analyzing the plurality of gray values of the X-ray image,
wherein the X-ray output part comprises:
an X-ray emitter emitting the X-rays; and
a shutter exposing the X-ray emitter to the outside by an opening operation.

2. The X-ray inspection device according to claim 1, wherein the transfer part comprises:
a stage on which the battery is disposed; and
a sensor module irradiating laser light onto the stage and generating a battery detection signal by analyzing a light quantity of reflected laser light.

3. The X-ray inspection device according to claim 2, further comprising a controller opening the shutter when the battery is disposed on the transfer part based on the battery detection signal.

4. The X-ray inspection device according to claim 1, wherein the X-ray output part further comprises a collimator forming an opening to limit the X-rays emitted to a region outside the region of interest.

5. The X-ray inspection device according to claim 4, wherein the collimator comprises at least two metal members disposed at predetermined locations.

6. The X-ray inspection device according to claim 5, wherein the metal members have a same thickness and include a same material.

7. The X-ray inspection device according to claim 5, wherein the inspector determines that the inspection settings are suitable when a first gray value of each of the metal areas corresponding to the metal members in the X-ray image is within a reference gray value range.

8. The X-ray inspection device according to claim 7, wherein the reference gray value range is set to different values for different locations of the metal areas.

9. The X-ray inspection device according to claim 7, wherein the inspector determines an average value of a maximum gray value and a minimum gray value in each of the metal areas as the first gray value.

10. The X-ray inspection device according to claim 5, wherein the inspector determines that the inspection settings are suitable when a difference between a first gray value of each of the metal areas corresponding to the metal members in the X-ray image and a second gray value of the region of interest in the X-ray image is within a reference value.

11. An operating method of an X-ray inspection device, the operating method comprising:
acquiring an X-ray image by detecting X-rays irradiated from an X-ray output part;
calculating a first gray value of each of metal areas corresponding to metal members in the X-ray image;
primarily determining whether a first gray value is within a reference gray value range;
determining a second gray value of a region of interest in the X-ray image;
secondarily determining whether a difference between the first gray value and the second gray value is within a reference value; and
determining the suitability of the inspection settings for a battery inspection when primary and secondary determinations satisfy criteria.

12. The operating method according to claim 11, further comprising, before the acquiring of the X-ray image, detecting the battery disposed on the transfer part and opening a shutter.
